(19) United States
(12) Patent Application Publication
(10) Pub. No.: US 2002/0166621 A1
(43) Pub. Date: Nov. 14, 2002

(54) Build-up wheel for tire bead

(76) Inventor: Rodney C. Marsden, Poland, NY (US)

Correspondence Address: Bernhard P. Molldrem, Jr., 333 East Onondaga Street, Syracuse, NY, 13202, US

(21) Appl. No.: 09/852,171

(22) Filed: May 10, 2001

(51) Int. Cl. B29C 35/00

(52) U.S. Cl. 156/187; 156/195

(57) ABSTRACT

A wire bead build-up wheel assembly for a single-wire bead-building process has a disk member with a peripheral groove for the bead wire, and an open core, and a hub that has a head and a threaded shaft. There are thrust bearings between the main disk member and the head of the hub, and between the main disk member and a second annular disk member. An axial sleeve bearing may be positioned over the hub shaft. A suitable retainer keeps the build-up wheel assembly together. The thrust bearings may have radially disposed bearing pins. An associated wire guide chute is formed of a pair of side plates mounted to a base or block.

### BACKGROUND OF THE INVENTION

The present invention relates to the manufacture of wire beads for the tire industry, and is more particularly concerned with a mechanism for guiding bead wire onto a bead forming wheel or drum. The invention is more specifically directed to an improved build-up wheel assembly or pay-on wheel assembly, and to the wire guide or guide chute associated with the build-up wheel.

In a typical bead forming operation, a leading end of a bead wire is attached to a gripper mechanism of the bead forming drum. Then the drum is rotated a predetermined number of turns to build up an annular bead or hoop of wire. Then the ends of the wire are sewn or bound to the hoop, and the bead is removed from the drum. A typical drum may have one or more generally trapezoidal annular grooves, and a wire bead is formed in each groove. The drum may be formed of a number of segments, so it can be collapsed to permit removal of the bead or beads. Because the wire bead has to be laid down in a pattern in the groove, a wire guide and build-up wheel, usually mounted on a guide arm, are used to position the bead wire in the groove.

The bead wire has a metal core and a tacky rubber coating, and this can cause a great deal of wear on the wire guide chute and the build-up wheel as the wire moves past or through them. After some number of beads have been created, the build-up wheel becomes so worn it has to be replaced. The guide chute is typically formed as a loop of a soft, mild steel and can easily become bent and worn.

Both the build-up wheel and the wire guide chute can be difficult and time-consuming to replace. The build-up wheel is usually of an open core design and has to be installed over a bearing hub on the machine's guide arm.

### OBJECTS AND SUMMARY OF THE INVENTION

Accordingly, it is an object of this invention to provide an improved build-up wheel and an improved wire guide that avoid the problems of the prior art.

It is a more specific object to provide a build-up wheel assembly of improved wear life and which facilitates installation and replacement.

It is another object to provide an improved bead wire guide of improved strength and which can be easily changed out when necessary, without undue down time.

In accordance with an aspect of the present invention, a wire bead build-up wheel useful in a single-wire bead-building process is constructed of an annular disk member having a peripheral groove extending circumferentially around it for the bead wire. A hub member has a head with a flat surface that faces the annular disk member and a threaded post that protrudes from the head and passes through the annular disk member. A second annular disk fits over the threaded post. There are first and second thrust bearings situated between the head of the hub member and the annular disk member, and between the second annular disk and the annular disk member. An axial bearing is situated over the post or shaft. A retaining ring or the equivalent holds the second disk, the first and second thrust bearings, the axial bearing, and the main annular disk member on the hub member. The assembly is treated as a unit, and when change out is necessary, it can be installed simply by screwing it in place in a receptacle on the associated guide arm. Preferably, the thrust bearings include pin bearings, with the pin rollers disposed axially relative to the annular disk member. The hub member head can have a knurled circumferential surface to facilitate installation of the build-up wheel assembly. The annular disk member is preferably formed of a hardened steel, which gives the build-up wheel a longer wear life and greater impact strength than the conventional build-up wheel.

According to another aspect of the invention, the wire guide or guide chute is made up of a base member having a nose member protruding from one end, to which a pair of guide plates are attached. The first guide plate is formed with an upper portion that attaches to the nose member, and a lower relieved portion. The second guide plate faces the first guide plate and has an upper portion aligned with the upper portion of the first guide plate and a lower portion that together with the relieved portion of the first guide plate defines a wire guide channel. A simple pin and screw arrangement, or equivalent means can be used for removably affixing the first and second guide plates to the nose member. A bar or strut may be located on the relieved portion of the first guide plate, the strut reaching to the second guide plate beneath the guide channel. Preferably, the guide plates each have a tapered lower edge.

The above and many other objects, features, and advantages of this invention will become apparent to persons skilled in the art from the ensuing description of a preferred embodiment, which is to be read in conjunction with the accompanying Drawing.

### BRIEF DESCRIPTION OF THE DRAWING

FIG. 1 is a perspective view of a portion of a bead forming wheel or drum, showing the associated guide arm with a build-up wheel assembly and a wire guide according to an embodiment of this invention.

FIG. 2 is another perspective view from beneath the guide arm and showing the bead wire entering the wire guide.

FIG. 3 is a schematic view showing the build-up wheel placing the bead wire in the associated channel in the bead forming wheel or drum.

FIG. 4 is an elevation view in partial section of the build-up wheel assembly of this embodiment.

FIG. 5 is a perspective view in partial section of the build-up wheel assembly of this embodiment.

FIG. 6 is an assembly view of the wire guide of this embodiment.

FIG. 7 are perspective view in partial assembly showing a portion of the guide arm with the build-up wheel and wire guide of this invention.

### DETAILED DESCRIPTION OF THE PREFERRED EMBODIMENTS

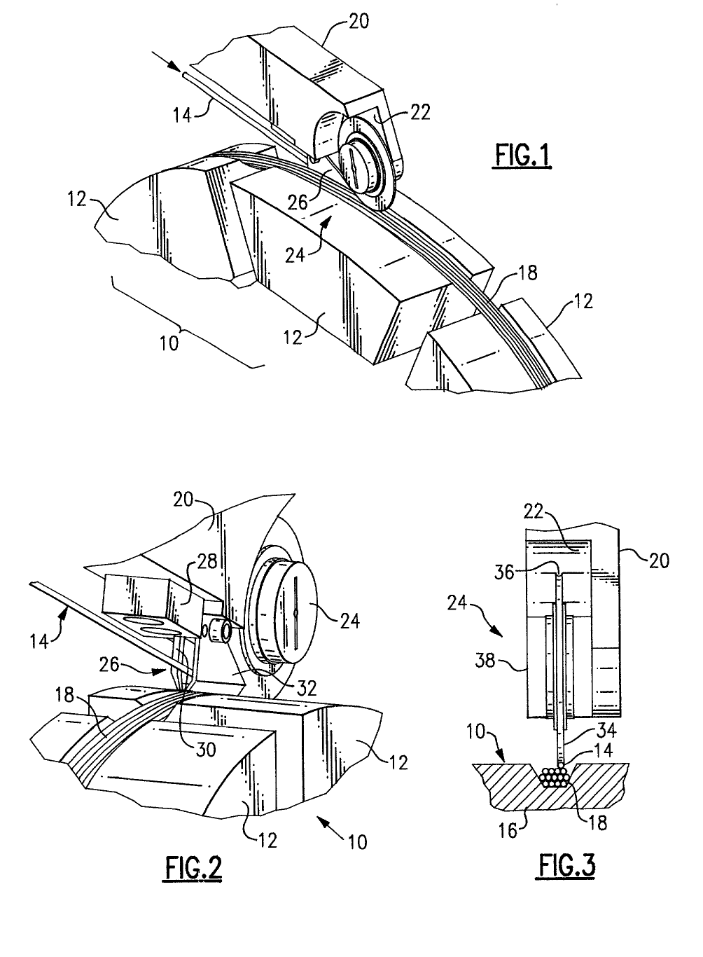

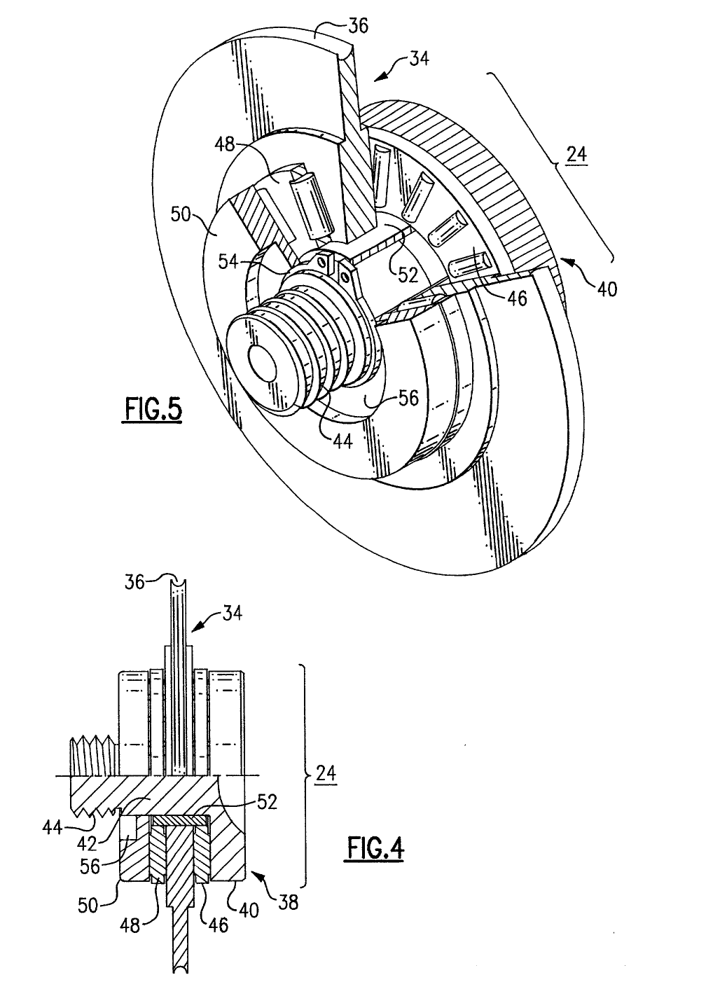

With reference to the Drawing, and initially to FIGS. 1, 2 and 3, a portion of a bead forming drum or wheel 10 is made up of a number of segments 12 and rotates for winding coils of a bead wire 14. Here the bead wire is laid down in a groove 16 that extends around the circumference of the bead forming wheel 10, allowing for the gaps between segments 12. This is a single-wire bead-forming technique, and here the wire is laid into the groove 16 in a pattern so that the resulting tire bead 18 has a hexagonal section. In this particular arrangement, the groove 16 has a generally trapezoidal shape (FIG. 3), but that is not an absolute necessity. Here only one groove 16 is shown, for a single bead wire 14. However, the bead forming drum can have a single groove or any number of grooves, with six being a common configuration. In that case, several wire beads would be formed simultaneously.

As a means of guiding the bead wire 14 as it is laid down in the groove, there is a guide arm 20, with a receptacle 22 at its distal end, here in the form of a somewhat cylindrical recess, in which a build-up wheel assembly 24 is mounted. This assembly 24 is sometimes referred to as a pay-on wheel, and serves to place the bead wire in the proper location during bead forming.

A wire guide 26 or guide chute is mounted on the guide arm 20 just in advance of the build-up wheel. The wire 14 passes through the wire guide 26 just before it reaches the build-up wheel.

In this embodiment, the wire guide 26 is comprised of a mounting block 28 or base that is affixed onto an underside of the guide arm 20, and a pair of side plates or guide plates 30 and 32.

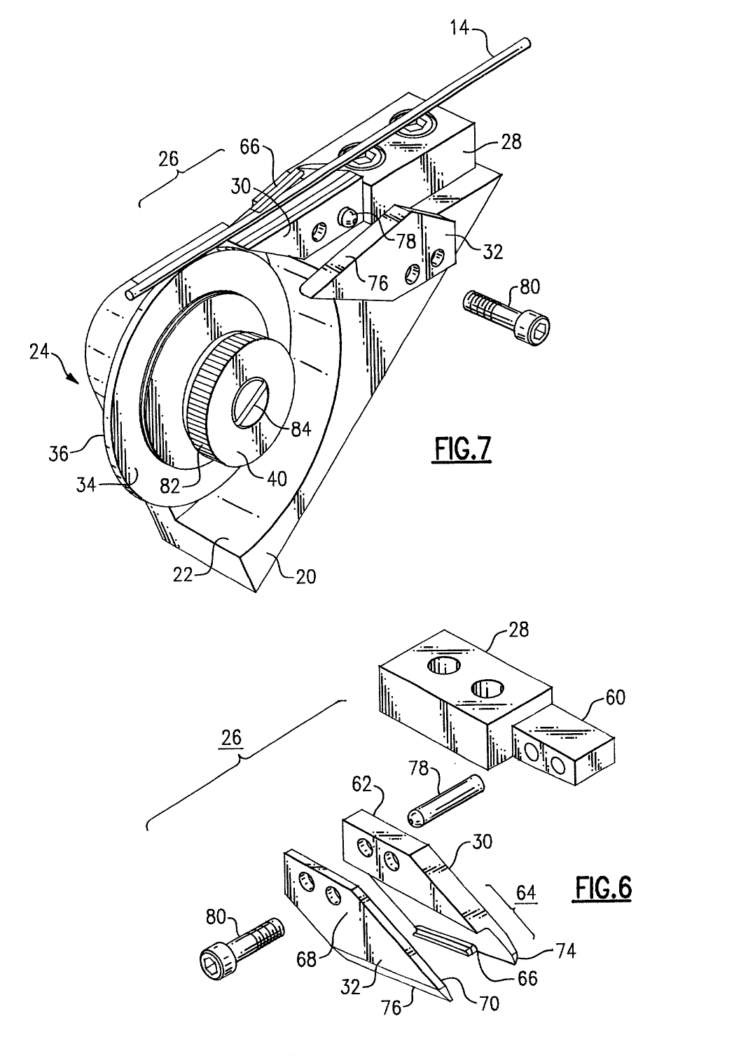

This assembly will be discussed in more detail in respect to FIGS. 6 and 7.

As shown in FIGS. 4 and 5, the build-up wheel assembly 24 has a main guide disk or wheel 34, which has a peripheral groove 36 around its circumference, with the bead wire 14 being received in this groove 36. The disk 34 has a central opening, and the disk is rotatably mounted on a hub 38. As shown, the disk 34 has a stepped thickness, with a thin outer portion towards the peripheral groove 36 and a thicker inner portion that serves as a thrust bearing surface. The hub 38 has a head 40 in the form of a disk or drum, and a stem or shaft 42 that protrudes from the head and has a threaded portion 44 at its distal end. There are a pair of pin roller assemblies 46 and 48 that are positioned against the inner portions of the disk 34. These have their bearing roller pins oriented in the radial direction. One of these pin roller assemblies 46 is positioned between the head 40 and the disk 34, and the other 48 is positioned between the disk 34 and an outer disk 50. As shown, there is an axial bearing, here in the form of a sleeve 52 positioned over the stem or shaft 42 within the central opening of the disk 34. The axial bearing may be of a self-lubricating material. A retainer ring 52 seats in an annular recess in the shaft 42 and holds the disk 34, the pin roller assemblies 46, 48, the outer disk 50 and the sleeve 52 in place on the hub 38. In this embodiment, there is a circular recess 56 in the outer face of the disk 50 to accommodate the retainer ring 52.

FIGS. 6 and 7 illustrate details of one embodiment of the wire guide 26. Here, the base or block 28 has a nose or protuberance 60 extending from one end, and serving as a place for mounting the left and right guide plates 30 and 32. The left guide plate 30 has an upper attachment portion 62, here with two holes for mounting onto the nose portion 60 of the block 28, and a lower recessed or relieved portion 64. There is a strut or bar 66 near the lower edge. The right guide plate 32 also has an upper attachment portion 68 with holes that align with the holes in the left guide plate 30 and the nose portion 60 of the block 28. Below this portion 68 is a flat plate portion 70, which cooperates with the relieved portion 64 of the other guide plate 30 to form a wire guide channel 72. The bead wire 14 passes through this channel 72 on its way to the build-up wheel and the bead forming drum. The strut 66 reaches beneath the channel 72 to the flat plate portion 70 of the guide plate 32. There are tapered or beveled lower edges 74 and 76 on the two guide plates 30 and 32, respectively. A pin 78 and bolt 80 fit into the holes in the nose portion 60 and the upper attachment portions of the two guide plates 30 and 32. The guide plates 30 and 32 can be easily removed and then cleaned or replaced, simply by removing the one bolt 80.

Additionally, as shown in FIG. 7, the hub 38 has a knurled circumferential surface 82 on the head 40 for screwing build-up wheel assembly 24 into a mating female threaded hole in the receptacle 22 of the guide arm 20. A screwdriver slot 84 is also provided on the flat portion of the head 40.

Preferably, the gap between the two plates 30 and 32, just behind the strut or bar 66, is of sufficient size to accommodate the bead wire 14.

Because of the construction of the build-up wheel assembly 24, the disk 34 can be formed of a long wearing tool steel. The assembly 24 can be factory-assembled, packaged and treated as a unit, so that it can be quickly installed or changed out, without having to do any field assembly of the build-up wheel. Also, the construction of the wire guide 26, with its two removable side plates 30 and 32, allows long wearing steel to be used in this assembly, avoiding the problems of its being bent and deformed during a bead building operation. Also, the wire guide 26 can be easily and quickly dismantled, cleaned, and reconstructed when it becomes clogged with tacky rubber material from the bead wire.

There are many other bead formers and bead building techniques besides what is shown and described here, but the build-up wheel and the wire guide arrangements of this invention can be adapted as need be for use with such other systems.

While the invention has been described in detail with respect to one preferred embodiment, it should be recognized that many alternative embodiments would become apparent to persons of skill in the art, and that many modifications and variations are possible which would not depart from the scope and spirit of this invention, as defined in the appended claims.

I claim:

1. Wire bead build-up wheel for use in a single-wire bead-building process, comprising:
an annular disk member having a peripheral groove extending circumferentially therearound;
a hub member having a head with a flat surface facing the annular disk member and a threaded post protruding from said head and passing through the annular disk member;
a second annular disk fitting over said threaded post;
a first thrust bearing between the head of said hub member and said annular disk member;
a second thrust bearing between the second annular disk and said annular disk member; and
retaining means holding said second disk, said first and second thrust bearings and said annular disk member on said hub member.

2. The wire bead build-up wheel according to claim 1 wherein said first and second thrust bearings include pin bearings disposed axially relative to said annular disk member.

3. The wire bead build-up wheel according to claim 1 wherein said hub member head has a knurled circumferential surface.

4. The wire bead build-up wheel according to claim 1 wherein said second disk has a central recess on a side away from the annular disk member for accommodating said retaining means.

5. The wire bead build-up wheel according to claim 1 wherein said annular disk member is formed of a hardened steel.

6. The wire bead build-up wheel according to claim 1 further comprising an axial bearing disposed over said post within said annular disk member.

7. Wire guide for use in assisting a build-up wheel in a single-wire tire bead building process, comprising:
a base member having an attachment portion;
a first guide plate having an upper portion attaching to the attachment portion of said base member and a lower portion;
a second guide plate facing said first guide plate with an upper portion aligned with the upper portion of the first guide plate and a lower portion that together with the lower portion of the first guide plate defines a wire guide channel; and
means for removably affixing said first and second guide plates to the attachment portion member of said base member.

8. Wire guide according to claim 7 wherein said lower portion of the first guide plate is a relieved portion defining a recess.

9. Wire guide according to claim 8 wherein said relieved portion of said first guide plate includes a strut reaching to said second guide plate beneath said guide channel.

10. Wire guide according to claim 7 wherein said first and second guide plates each have a tapered lower edge.

11. Wire guide according to claim 7 wherein said attachment portion includes a nose member protruding from said base member.

12. Wire guide according to claim 11 comprising a pin mounted into an opening in said nose member and receiving aligned openings in the upper portions of said first and second guide plates.
